(19) United States
(12) Patent Application Publication
(10) Pub. No.: US 2003/0002582 A1
(43) Pub. Date: Jan. 2, 2003

(54) Multi-resolution boundary encoding applied to region based still image and video encoding

(76) Inventor: Pere Obrador, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/879,168

(22) Filed: Jun. 13, 2001

(51) Int. Cl. H04N 7/12

(52) U.S. Cl. 375/240.11; 375/240.08; 375/240.01; 375/240.18; 375/240.19

(57) ABSTRACT

A method and an associated apparatus applies multi-resolution boundary encoding to region based still image and video encoding, allowing better error correction for low frequency transmission. High frequency bands that are less protected may be discarded, leaving only lower frequency representation. By using JSCC techniques, a receiver with low resolution capability or low channel bandwidth may still render a close approximation of a boundary despite error in transmission.

### TECHNICAL FIELD

The present invention relates to still image and video encoding, and, in particular, to region based still image and video encoding.

### BACKGROUND

Video encoding may include image encoding and boundary encoding. Existing boundary encoding techniques, such as MPEG-4, typically use differential chain codes for generating region based encoding. An examples of differential chain encoding is described in Muller, et. al., “Progressive Transmission of Line Drawings Using the Wavelet Transform,” IEEE Transactions On Image Processing, Vol. 5, No. 4, April 1996. Differential chain encoding techniques typically use directional vectors on a square grid of for example, 4×4 pixels.

However, MPEG-4 and other differential chain encoding techniques only code the pixel boundaries of the regions, and thus may not have an overall multi-resolution representation. As a result, if some information is lost in transmission, the boundary of the whole region may be misplaced.

Fourier series based encoding is the next step in boundary encoding, with coordinates of a curve periodically extended and Fourier transformed. However, Fourier series encoding only generates good localization in frequency, but not good localization in space. Accordingly, once there is error in transmission, i.e., some of the coefficients or data bits are lost, the boundary may be misplaced.

### SUMMARY

A method for applying multi-resolution boundary encoding to region based still image and video encoding includes dividing an original image into a plurality of regions and detecting a plurality of boundaries associated with the plurality of the regions. The method further includes encoding each of the plurality of the boundaries so that each of the plurality of the boundaries contains different resolution coefficients. The method also includes decomposing each of the plurality of the regions in the original image into one or more subbands using the plurality of the boundaries with the highest resolution coefficients, and successively decomposing each of the plurality of the regions in a subband with lower resolution coefficients into one or more subbands using the plurality of the boundaries with lower resolution coefficients.

The method for applying multi-resolution boundary encoding to region based still image and video encoding further includes transmitting the lowest resolution boundary and image information, and successively transmitting higher resolution boundary and image information.

This method uses multi-resolution encoding for image and for boundary and allows for better error correction for low frequency transmission. By using joint source channel coding (JSCC) techniques, a receiver with low resolution capability or low channel bandwidth may still render a close approximation of a boundary despite error in transmission.

### DESCRIPTION OF THE DRAWINGS

The preferred embodiments of the multi-resolution encoding will be described in detail with reference to the following figures, in which like numerals refer to like elements, and wherein:

FIG. 1 illustrates exemplary hardware components of a computer that may be used to implement the multi-resolution boundary encoding;

FIG. 2 illustrates an exemplary boundary encoded at full resolution;

FIGS. 3(a) and 3(b) illustrate an exemplary method for encoding two one-dimensional periodical signals using wavelet based encoding at different resolution levels;

FIGS. 4(a)-(c) illustrates how the exemplary boundary shown in FIG. 2 is represented in multi-resolution encoding;

FIG. 5(a) illustrates an exemplary multi-resolution representation for boundaries;

FIG. 5(b) illustrates an exemplary comparison of Fourier series encoding and wavelet based encoding with or without transmission errors;

FIGS. 6(a)-(c) illustrate an exemplary image encoding using subband encoding technique;

FIGS. 7(a)-(d) illustrate an exemplary multi-resolution decomposition of an image and an associated boundary;

FIGS. 8(a)-(e) illustrate an exemplary process of progressive reconstruction of the image and the associated boundary; and

FIG. 9 is a flow chart of the exemplary decomposition and reconstruction process illustrated in FIGS. 7 and 8 using multi-resolution boundary encoding.

### DETAILED DESCRIPTION

A method and an associated apparatus applies multi-resolution boundary encoding to region based still image and video encoding, allowing better error correction for low frequency bands. High frequency bands may be less protected, leaving only lower frequency representation highly protected. A receiver with low resolution capability or low channel bandwidth, such as a wireless device, may still render a close approximation of a boundary despite error in transmission.

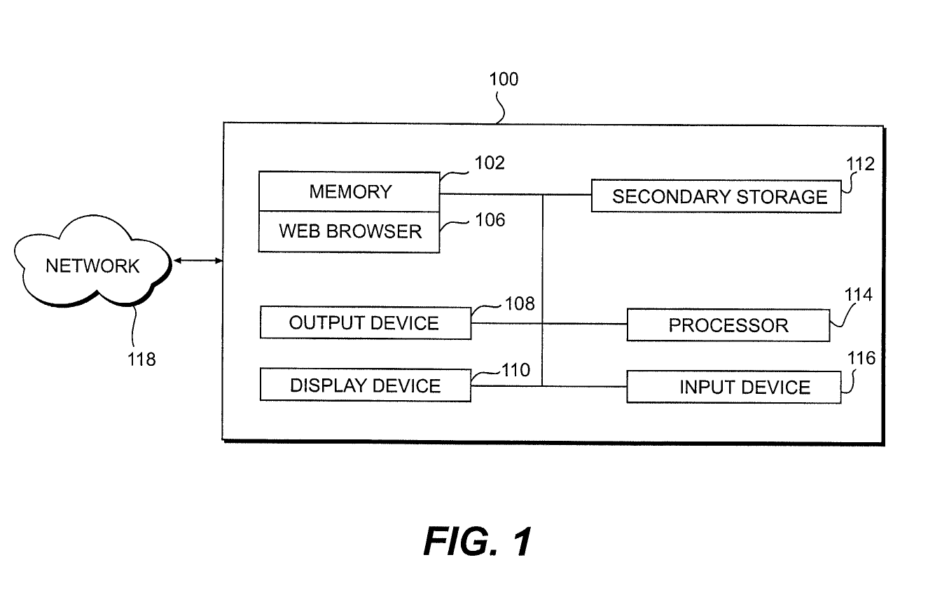

FIG. 1 illustrates exemplary hardware components of a computer 100 that may be used to implement the multi-resolution boundary encoding. The computer 100 includes a connection with a network 118 such as the Internet or other type of computer or telephone networks. The computer 100 typically includes a memory 102, a secondary storage device 112, a processor 114, an input device 116, a display device 110, and an output device 108.

The memory 102 may include random access memory (RAM) or similar types of memory. The memory 102 may be connected to the network 118 by a web browser 106. The web browser 106 makes a connection via the world wide web (WWW) to other computers known as web servers, and receives information from the web servers that are displayed on the computer 100. The secondary storage device 112 may include a hard disk drive, floppy disk drive, CD-ROM drive, or other types of non-volatile data storage, and may correspond with various databases or other resources. The processor 114 may execute information stored in the memory 102, the secondary storage 112, or received from the Internet or other network 118. The input device 116 may include any device for entering data into the computer 100, such as a keyboard, key pad, cursor-control device, touch-screen (possibly with a stylus), microphone, or video camera (not shown). The display device 110 may include any type of device for presenting visual image, such as, for example, a computer monitor, flat-screen display, or display panel. The output device 108 may include any type of device for presenting data in hard copy format, such as a printer (not shown), and other types of output devices include speakers or any device for providing data in audio form. The computer 100 can possibly include multiple input devices, output devices, and display devices.

Although the computer 100 is depicted with various components, one skilled in the art will appreciate that the computer can contain additional or different components. In addition, although aspects of an implementation are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 100 to perform a particular method.

Any signal can be represented with scaling functions and wavelet functions. The scaling functions, wavelet functions, and other image encoding related mathematical formulas and algorithms are described, for example, in Chuang, et. al., “Wavelet Descriptor of Planar Curves: Theory and Applications,” IEEE Transactions on Image Processing, Vol.5, No. 1, January 1996, which is incorporated herein by reference. Chuang, et. al. describe a hierarchical planar curve descriptor that, by using a wavelet transform, decomposes a curve into components of different scales so that the coarsest scale components carry the global approximation information while the finer scale components contain the local detailed information. The wavelet descriptor is shown to have many desirable properties such as multi-resolution representation, invariance, uniqueness, stability, and spatial localization.

Multi-resolution pyramid encoding for image is described, for example, in U.S. Pat. No. 5,477,272, entitled “Variable-Block Size Multi-Resolution Motion Estimation Scheme for Pyramid Coding,” which is incorporated herein by reference. U.S. Pat. No. 5,477,272 describes a variable-size block multi-resolution motion estimation scheme that can be used to estimate motion vectors in subband encoding, wavelet encoding and other pyramid encoding systems for video compression.

In multi-resolution encoding, image information is sent in increments. Every time more information is transmitted, the image may be better described and rendered. For example, a single sine wave may be a first approximation of a square wave, which represents an original waveform. Adding more information, for example, a double frequency sine wave with different amplitude, on top of the original sine wave may generate a second approximation of the square wave. A third approximation may be generated by adding a higher frequency sine wave with smaller amplitude, and so on. Every time a new sine wave is added, a better approximation of the square wave, the original image, may be generated.

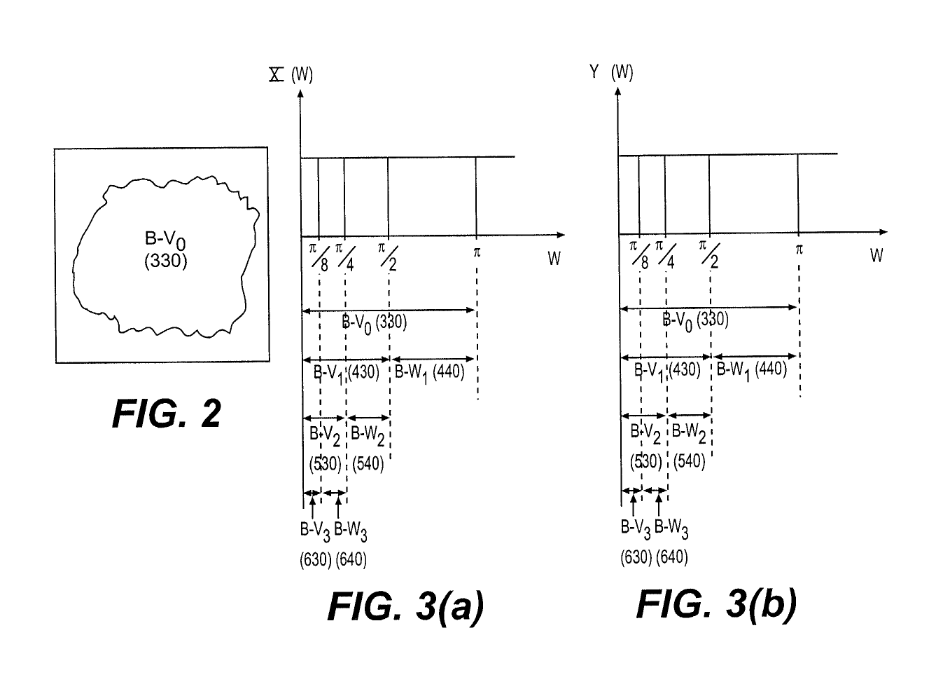

Multi-resolution encoding techniques may be applied to boundary encoding. In multi-resolution boundary encoding, a periodic wave transfer may be generated with different contents of frequencies. FIG. 2 illustrates an exemplary boundary B-V₀ 330 encoded at full resolution. The boundary is composed of two coordinates, i.e., x(t) and y(t), that evolve in “t”. The combination of the two coordinates generates the whole boundary.

The boundary may be encoded using two one-dimensional periodic wavelet series. Wavelet series are described, for example, in “Progressive Transmission of Line Drawings Using the Wavelet Transform” by Muller, et. al., IEEE Transactions on Image Processing, Vol.5, No. 4, April 1996, which is incorporated herein by reference. Muller, et. al. present a method to apply progressive transmission to line drawings using wavelet transform.

FIGS. 3(a) and 3(b) illustrate an exemplary method for encoding, i.e., decomposing, two one-dimensional periodical signals using wavelet based encoding at different resolution levels. Examples of one-dimensional periodical signal encoding are described, for example, in “Wavelets and Subband Coding” by Vetterli and Kovacevic, ISBN 0-13-097080-8,1995,221-223, which is incorporated herein by reference.

Referring to FIG. 3(a), a one-dimensional curve X(w) is decomposed by subdividing the spectrum represented by frequency “w” and generating frequency coefficients for x(t). For example, wavelet coefficients in B-V₀ 330 expand all frequency bands from 0 to π. Subdividing the spectrum generates coefficients in B-V₁ 430, which contains lower frequencies from 0-π/2, and B-W₁ 440, which contains higher frequencies from π/2 to π. Further dividing the spectrum produces coefficients in B-V₂ 530, which carries lower frequency contents from 0-π/4, and B-W₂ 540, which carries higher frequency contents from π/4 to π/2. Yet further dividing the spectrum produces coefficients in B-V₃ 630, which contains lower frequency contents from 0-π/8, and B-W₃ 640, which carries higher frequency contents from π/8 to π/4.

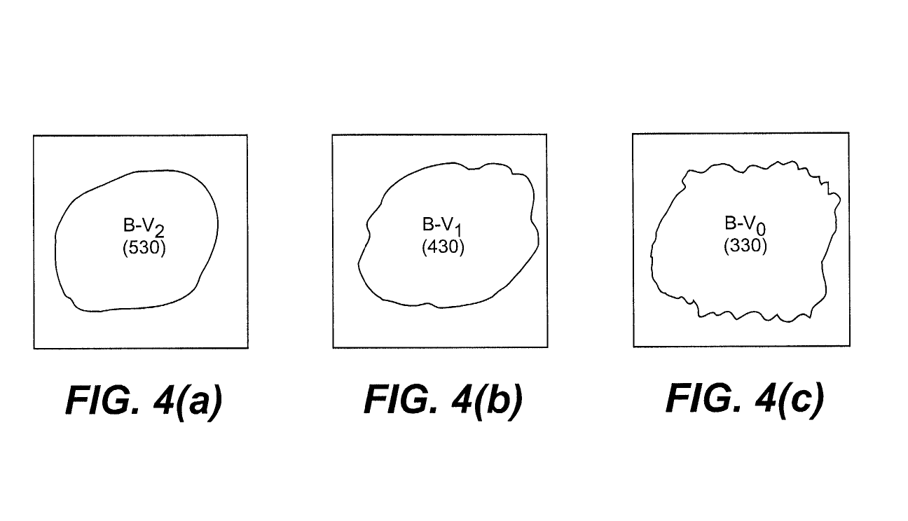

FIGS. 4(a)-(c) illustrates how the exemplary boundary shown in FIG. 2 is represented in multi-resolution encoding. First, a few data bits with lowest frequency coefficients, which represent the most basic boundary information, are sent to a receiver during transmission. Then, more data bits with higher frequency coefficients may be sent to render a better approximation of the boundary. The more data bits with higher frequency coefficients are transmitted, the closer representation the boundary is to the original image.

As shown in FIG. 4(a), X(w) and Y(w), which form the transformed boundary, may be reconstructed by first receiving B-V₂ 530, which contains the lowest frequency contents. Then, B-W₂ 540, which carries mid-range frequency contents, may be received, thereby creating a better boundary. B-V₁ 430, shown in FIG. 4(b), may be generated by combining B-V₂ 530 and B-W₂ 540. Lastly, B-W₁ 440, which contains the highest frequency contents, may be received, and B-V₀ 330, the original boundary shown in FIG. 4(c), may be generated by combining B-V₁ 430 and B-W₁ 440. As a result, B-V₀ 330 is the combination of B-V₂ 530, B-W₂ 540 and B-W₁ 440.

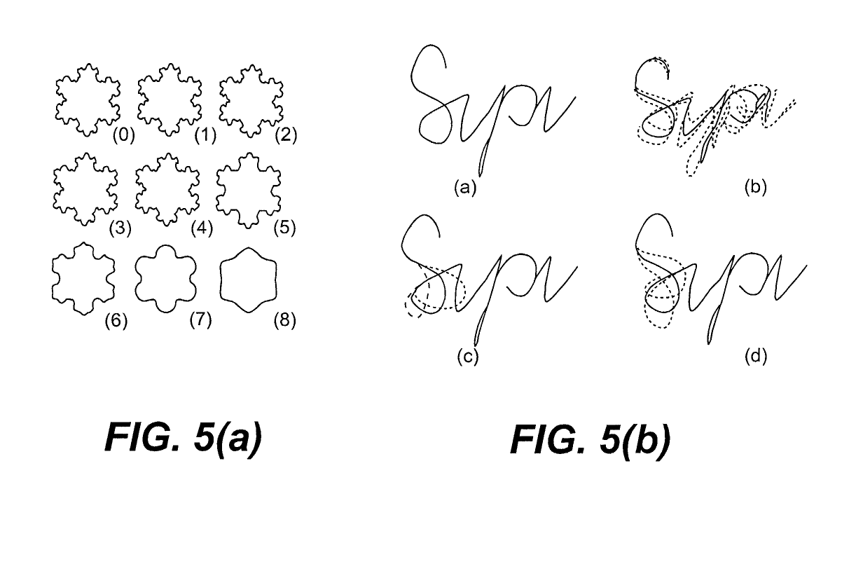

FIG. 5(a) illustrates an exemplary multi-resolution representation for boundaries. An image, such as a snowflake, may be transmitted by sending frequency coefficients in increments. The original image with the highest frequency coefficients is shown in (0). The image with the lowest frequency coefficients, i.e., the basic shape, is shown in (8). If a receiver has higher transmission capability, higher frequency coefficients may be added to generate the image shown in (7), and so on. As illustrated in multi-resolution wavelet based boundary encoding, each time more information is received, the image boundary may be enhanced slightly with higher resolution, i.e., more detail. As for the final layers of transmission shown, for example, in (3), (2), (1), the enhancements generated may not be perceivable by human visual system, and the coefficients that generate (3), (2), (1) do not need to be protected against channel errors. Accordingly, high frequency bands may be discarded, leaving only lower frequency representation. Multi-resolution boundary encoding enables the basic shape of boundaries to be preserved by transmitting only a few coefficients.

Multi-resolution wavelet based boundary encoding offers a better approach than chain codes or Fourier series encoding, where if one data bit in the chain code is missing, the whole boundary is misplaced. FIG. 5(b) illustrates an exemplary comparison of Fourier series encoding and wavelet based encoding. Fourier series based encoding uses sine and cosine infinite waveforms, thus there is no spatial representation. If the frequency of the infinite waveform is changed slightly, the overall appearance of the image and boundary may be changed. The wavelet transform, however, has good localization both in space and in frequency.

The original waveform is shown in (a). Changing one coefficient slightly in the Fourier series encoding generates (b), while changing the similar coefficients slightly in wavelet based encoding generates (c) and (d). As illustrated, in Fourier series encoding, an error in transmission, represented by a slight change in one coefficient, disturbs the entire boundary. On the other hand, in wavelet based encoding, a similar error results in localized movement of the boundary. Therefore, if errors exist in the transmission, a receiver is still able to recover the basic coefficients and render a close approximation of the boundary.

The advantage of localization of modification may be shown best in wireless image transmission, where noisy channels are used and errors frequently occur. An error in transmission may affect one or more of the coefficients, typically the high frequency coefficients because the high frequency coefficients are not as protected as the low frequency coefficients. In Fourier series encoding, such errors may cause the entire image boundary to be misplaced. However, wavelet based encoding enables the boundary to remain the same, except for the isolated region subject to the error, as illustrated in FIG. 2(b). Accordingly, wavelet based encoding, more localized and more resilient to errors in transmission, is a preferred encoding method for describing boundaries.

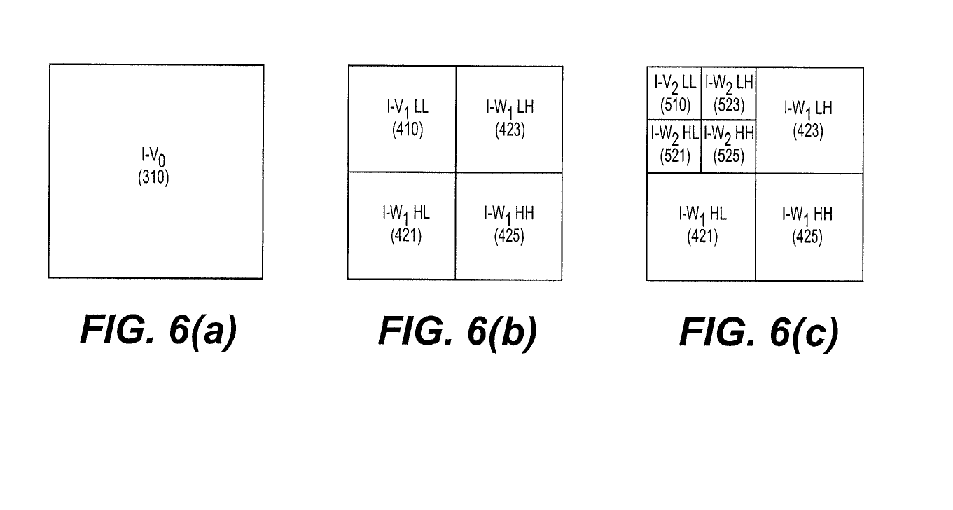

FIGS. 6(a)-(c) illustrate an exemplary image encoding using a subband coding (SBC) technique. Region based subband coding (RBSBC) is described, for example, in “A Region-Based Subband Coding Scheme” by Casas, et. al., Signal Processing: Image Communication 10 (1997) 173-200, which is incorporated herein by reference. Casas, et. al. disclose a region-based subband encoding scheme intended for efficient representation of the visual information contained in image regions of arbitrary shape. QMF filters are separately applied inside each region for the analysis and synthesis stages, using a signal-adaptive symmetric extension technique at region borders. The frequency coefficients corresponding to each region are identified over the various subbands of the decomposition, so that the encoding steps, namely, bit-allocation, quantization and entropy encoding, can be performed independently for each region.

An original image I-V₀ 310 is shown in FIG. 6(a). I-V₀ 310 may be filtered and downsampled to generate subbands I-V_{1LL} 410, I-W_{1HL} 421, I-W_{1LH} 423, and I-W_{1HH} 425, as illustrated in FIG. 6(b). The frequency representations are illustrated in Table 1. The subbands I-V_{1LL} 410, I-W_{1HL} 421, I-W_{1LH} 423, and I-W_{1HH} 425, drawn on a smaller (¼ size) grid, may be combined to reconstruct I-V₀ 310, the original image.

TABLE 1

| | Horizontal Frequencies | Vertical Frequencies |
|---|---|---|
| LL | Low Pass | Low Pass |
| LH | Low Pass | High Pass |
| HL | High Pass | Low Pass |
| HH | High Pass | High Pass |

Referring to FIG. 6(c), the subband I-V_{1LL} 410 may be further filtered and downsampled to generate subbands I-V_{2LL} 510, I-W_{2HL} 521, I-W_{2LH} 523, and I-W_{2HH} 525. The subbands I-V_{2LL} 510, I-W_{2HL} 521, I-W_{2LH} 523, and I-W_{2HH} 525, drawn on a yet smaller (1/16 size) grid, may be combined to reconstruct I-V_{1LL} 410.

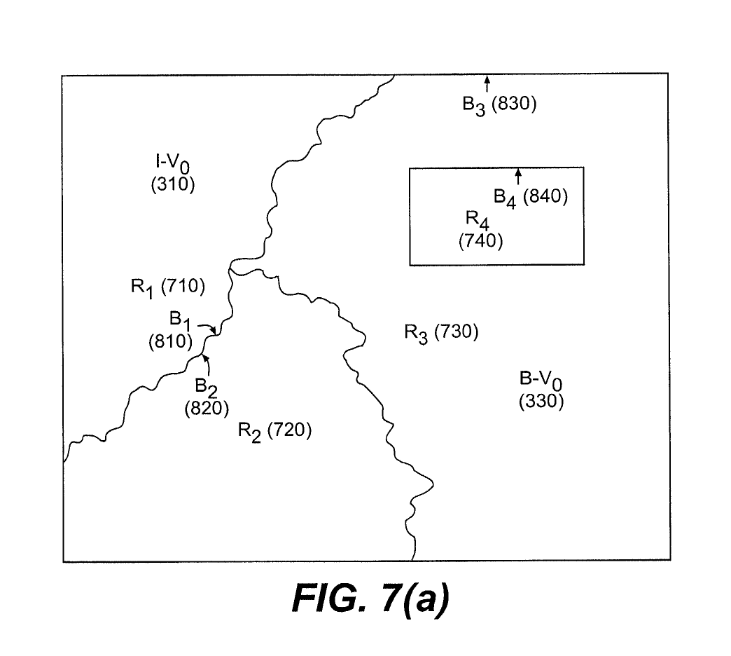

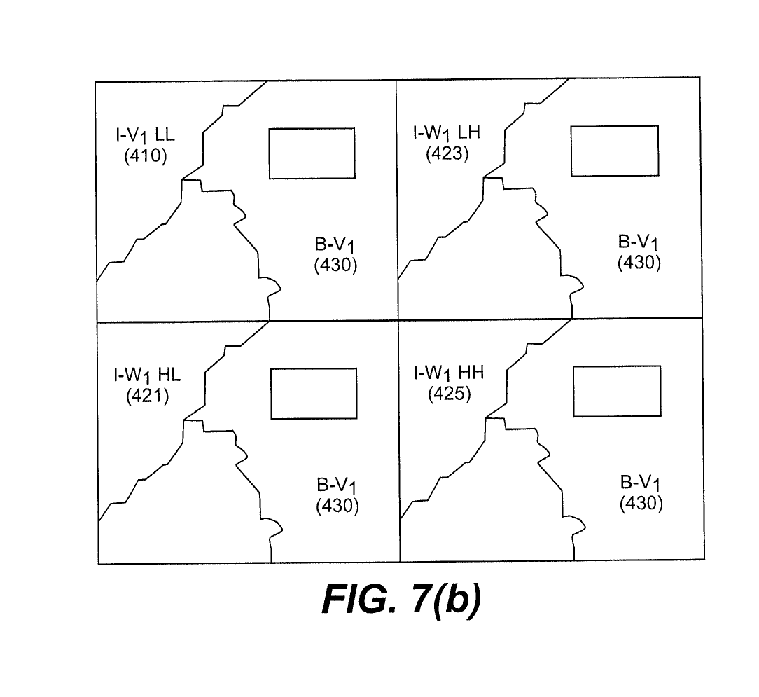

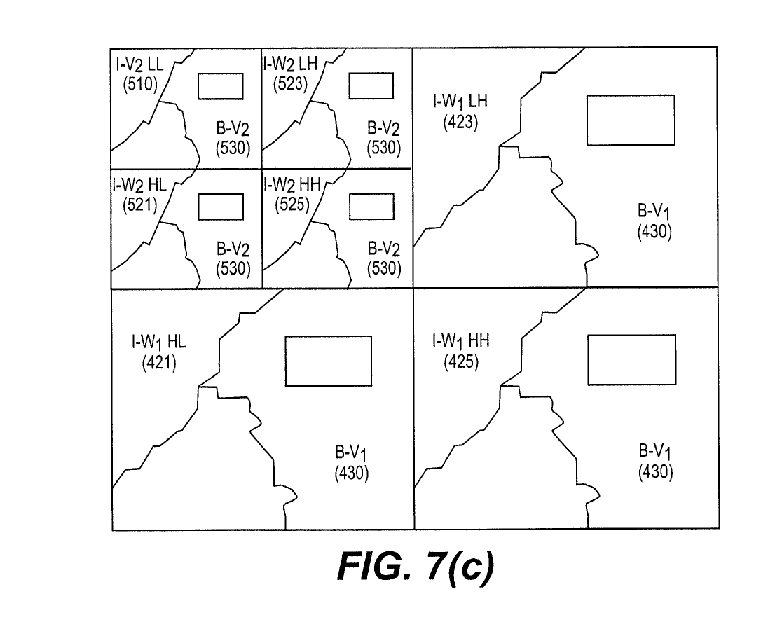

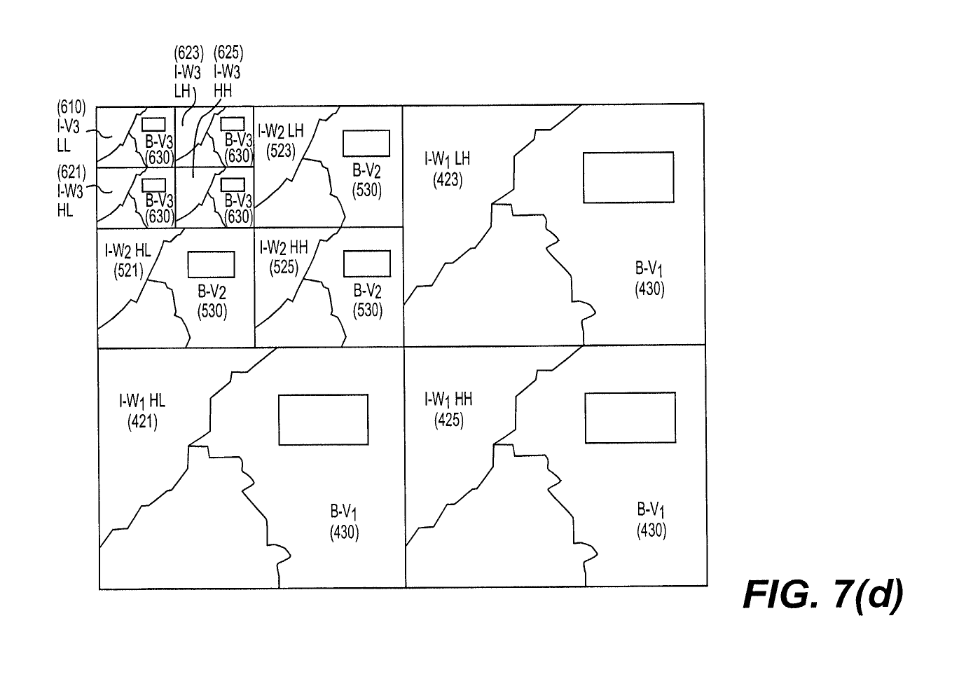

FIGS. 7(a)-(d) illustrate an exemplary multi-resolution decomposition of an image and an associated boundary. FIG. 7(a) illustrates an original image I-V₀ 310 composed of a set of regions, i.e., R₁ 710, R₂ 720, R₃ 730, and R₄ 740. The Regions are defined by a set of boundaries in B-V₀ 330, i.e., B₁ 810, B₂ 820, B₃ 830, and B₄ 840. Referring to FIG. 7(b), the original image I-V₀ 310 may be filtered and downsampled to generate subbands I-V_{1LL} 410, I-W_{1HL} 421, I-W_{1LH} 423, I-W_{1HH} 425 for each of the regions within the image. I-V_{1LL} 410 may be generated using low pass horizontal and low pass vertical (LL) frequency filters, I-W_{1BL} 421 may be generated using high pass horizontal and low pass vertical (HL) frequency filters, I-W_{1LH} 423 may be generated using low pass horizontal and low pass vertical (LH) frequency filters, and I-W_{1HH} 425 may be generated using high pass horizontal and high pass vertical (HH) frequency filters. All four subbands have the same boundary resolution, i.e., B-V₁ 430.

FIG. 7(c) illustrates a further decomposition, where the LL frequency subband I-V_{1LL} 410 is further filtered and downsampled for each of the regions, generating smaller subbands I-V_{2LL} 510, I-W_{2HL} 521, I-W_{2LH} 523, I-W_{2HH} 525. The subbands I-W_{1HL} 421, I-W_{1LH} 423, I-W_{1HH} 425 remain the same. The subbands I-V_{2LL} 510, I-W_{2HL} 521, I-W_{2LH} 523, I-W_{2HH} 525 have the same boundary resolution, i.e., B-V₂ 530, which has a lower resolution than B-V₁ 430.

FIG. 7(d) illustrates another level of decomposition, where the LL frequency subband I-V_{2LL} 510 is further filtered and downsampled for each of the regions, generating yet smaller subbands I-V_{3LL} 610, I-W_{3HL} 621, I-W_{3LH} 623, I-W_{3HH} 625. The subbands I-W_{2HL} 521, I-W_{2LH} 523, I-W_{2HH} 525 remain the same as before. The subbands I-V_{3LL} 610, I-W_{3HL} 621, I-W_{3LH} 623, I-W_{3HH} 625 have the same boundary resolution, i.e., B-V₃ 630, which has a yet lower resolution than B-V₂ 530.

Decomposition may be performed as many times as necessary to encode the image and the corresponding boundary. Because downsampling is typically performed in both directions, one-fourth of the original data remains after each filtering. After filtering, a pyramid is generated with different frequency contents, i.e., resolutions. However, only four or five decompositions are typically performed. As a result of the multiple levels of decomposition, a complete image compression may be generated based on wavelet coefficients for the boundary and subband coefficients for the image.

In transmission, image and boundary information may be sent using joint source channel coding (JSCC) to protect the information against channel errors. JSCC describes techniques in which the compression function and the error control function in a communication system are combined in some way. For example, encoding of the boundary and image may be modified so that different resolutions may be protected unequally against errors in transmission channels, i.e., the most important coefficients with respect to the human visual system (HVS) may be well protected, where the least important coefficients are less protected.

For example, when video signals are transmitted, image and corresponding boundary coefficients with the lowest resolution may be sent first. Next, image and boundary coefficients with a higher resolution may be transmitted, and so on. There are more data bits, i.e., energy, to be sent to encode a boundary in a subband with higher frequency. Image compression in source encoding is, in part, obtained by removing or coarsely encoding some of the coefficients in the higher frequency bands, i.e., quatitization process, as the HVS typically may not notice the difference. Channel encoding assigns error protection to the image and boundary information, and JSCC organizes the source coded coefficients in the order of importance with respect to the HVS. JSCC then applies channel encoding techniques to the source coded coefficients, providing more protection to the more important, i.e., low frequency, coefficients and less protection to the less important, i.e., high frequency, coefficients.

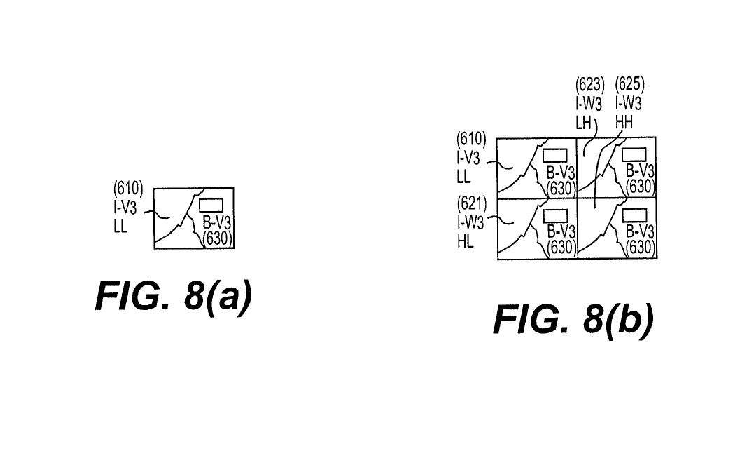

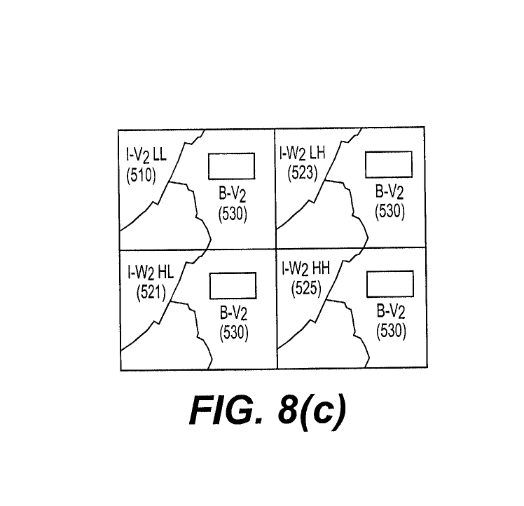

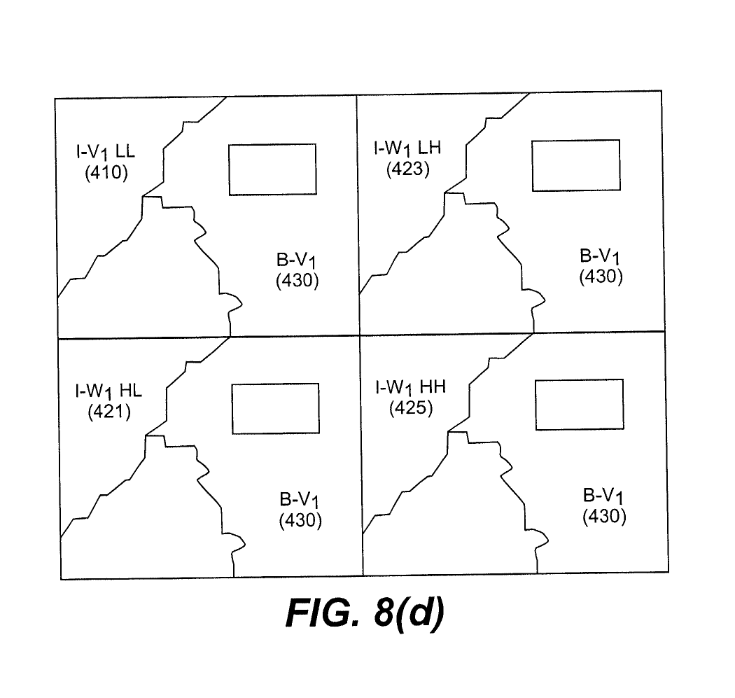

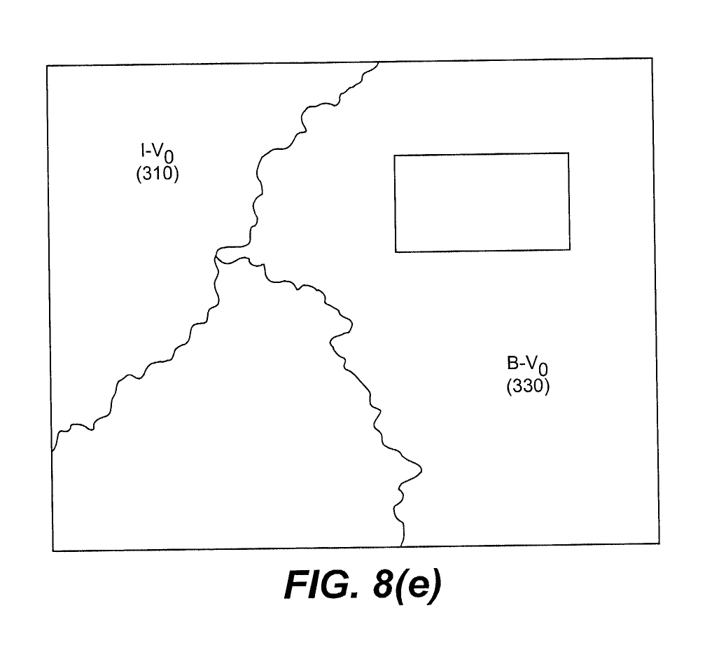

FIGS. 8(a)-(e) illustrate an exemplary process of progressive reconstruction of a decomposed image and an associated boundary. First, referring to FIG. 8(a), boundary information with the lowest resolution, i.e., B-V₃ 630, may be transmitted. Then, image information in the lowest subband I-V_{3LL} may be sent to fill the boundary. The lowest resolution boundary and image information, which are well protected against noises and transmission errors, are good representations of the original image at lower frequency. A receiver with low bandwidth may still recover this basic approximation.

Referring to FIG. 8(b), image information in the other three subbands I-W_{3HL} 621, I-W_{3LH} 623, and I-W_{3HH} 625 may be sent. The four subbands I-V_{3LL} 610, I-W_{3HL} 621, I-W_{3LH} 623, and I-W_{3HH} 625 share the same boundary resolution, i.e., B-V₃ 630. This level of image information is less protected against errors. A handheld wireless device, which operates in noisy channels and has smaller displays, typically only receives this level of approximation. However, the handheld wireless device may still render a video on the small display, which is a close representation of the original boundary and image.

In FIG. 8(c), the four subbands I-V_{3LL} 610, I-W_{3HL} 621, I-W_{3LH} 623, and I-W_{3HH} 625 may be combined to reconstruct the image information in I-V_{2LL} 510. Next, higher resolution boundary information in B-W₃ 640 (not shown in FIG. 8) may be sent. B-V₃ 630 and B-W₃ 640 may be combined to reconstruct B-V₂ 530, which has a higher resolution. Then, image information in the other three subbands I-W_{2HL} 521, I-W_{2LH} 523, and I-W_{2HH} 525 may be transmitted. Again, the subbands I-V_{2LL} 510, I-W_{2HL} 521, I-W_{2LH} 523, and I-W_{2HH} 525 share the same boundary resolution, i.e., B-V₂ 530. The higher resolution boundary and image information are even less protected against transmission errors.

Similarly, in FIG. 8(d), the subbands I-V_{2LL} 510, I-W_{2HL} 521, I-W_{2LH} 523 and I-W_{2HH} 525 may be combined to reconstruct the image information in I-V_{1LL} 410. Next, higher resolution boundary information in B-W₂ 540 (not shown in FIG. 8) may be sent. B-V₂ 530 and B-W₂ 540 may be combined to reconstruct B-V₁ 430, which has yet a higher resolution. Then, image information in the other three subbands I-W_{1HL} 421, I-W_{1LH} 423, and I-W_{1HH} 425 may be transmitted. Once again, the subbands I-V_{1LL} 410, I-W_{1HL} 421, I-W_{1LH} 423, and I-W_{1HH} 425 share the same boundary resolution, i.e., B-V₁ 430. The boundary and image at this level of resolution are more vulnerable to errors in transmission, because they are not well protected in the channel coding steps.

Lastly, referring to FIG. 8(e), the subbands I-V_{1LL} 410, I-W_{1HL} 421, I-W_{1LH} 423, and I-W_{1HH} 425 may be combined to reconstruct the original image I-V_{0LL} 310. The original image I-V_{0LL} 310 may be reproduced at a receiver. In this embodiment, the highest frequency coefficients in B-W₁ 440 do not need to be transmitted. If a receiver, for example, a high definition television or a desktop computer, is able to receive the levels of coefficients described above without error, the receiver may receive a high resolution high quality video scene, or even recover the original image, as shown in FIG. 8(e).

Accordingly, multi-resolution encoding both in boundary and in image allows a system designer to protect different sets of coefficients according to transmission channel's condition. Different receivers, using different channels, may receive different amount of bits per second, i.e., bandwidth. Hand held low resolution devices may utilize only lower frequency resolution, which is well protected. Other receivers, such as high definition televisions, use better channels with higher frequency band and can receive better image quality.

The image encoding and the boundary encoding use the same subbands for convenience purposes only. The two types of encoding may be performed separately and do not need to use the same subbands. In addition, instead of using RBSBC for the image encoding, other encoding methods may be used.

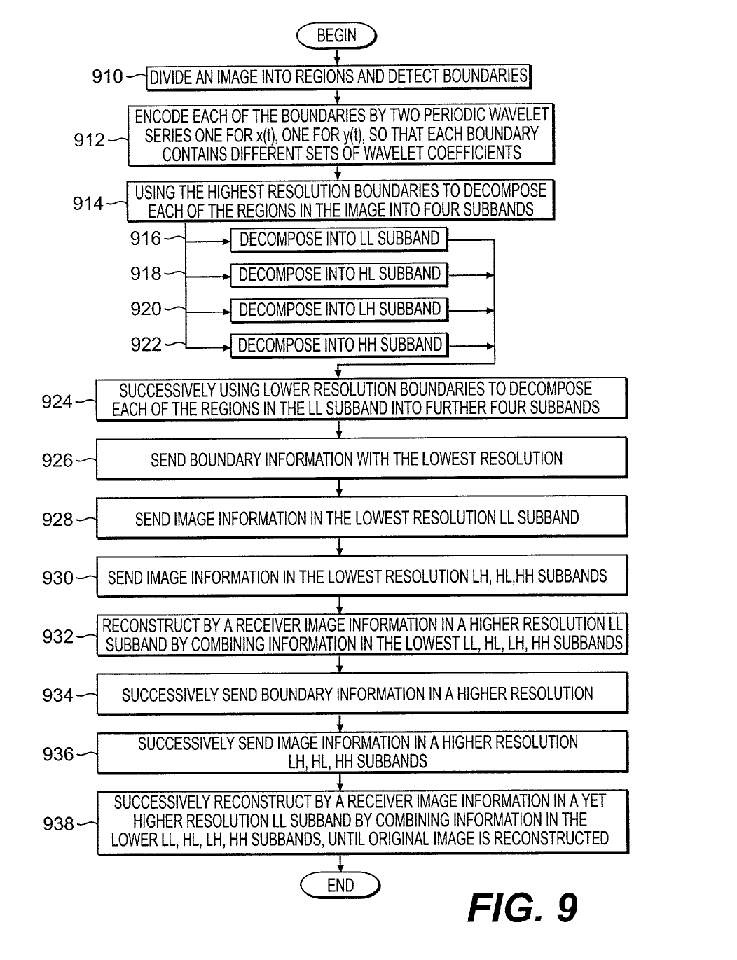

FIG. 9 is a flow chart of the exemplary decomposition and reconstruction process illustrated in FIGS. 7 and 8 using multi-resolution boundary encoding. An original image I-V₀ 310 may be divided into a plurality of regions, such as R₁ 710, R₂ 720, R₃ 730, and R₄ 740, step 910. A plurality of boundaries, such as B₁ 810, B₂ 820, B₃ 830, and B₄ 840, may be detected, step 910. Next, each of the boundaries may be encoded by two periodic wavelet series, one for x(t) and one for y(t), so that each boundary may contain different sets of wavelet coefficients, step 912. For example, for a three level decomposition, B-V₀ 330 may be composed of 2N wavelet coefficients, N for x(t) and N for y(t), B-V₁ 430 may be composed of N wavelet coefficients, N/2 for x(t) and N/2 for y(t), B-V₂ 530 may be composed of N/2 wavelet coefficients, N/4 for x(t) and N/4 for y(t), and B-V₃ 630 may be composed of N/4 wavelet coefficients, N/8 for x(t) and N/8 for y(t).

Next, using the boundaries with the highest resolution, i.e., B-V₀ 330, each of the regions in the original image I-V₀ 310 may be decomposed into, for example, four subbands, using a RBSBC scheme, step 914. The four subbands may be LL subband I-V_{1LL} 410, HL subband I-W_{2HL} 521, LH subband I-W_{2LH}, and HH subband I-W_{2HH}, steps 916, 918, 920, and 922, respectfully. In the next step, using lower resolution boundaries, each of the regions in the LL subband may be successively decomposed into further four LL, LH, HL, and HH subbands, step 924. For example, using the boundary B-V₁ 430, each of the regions in the LL subband, i.e., I-V_{1LL} 410, may be further decomposed into I-V_{2LL} 510, I-W_{2HL} 521, I-W_{2LH} 523, I-W_{2HH} 525. In addition, using the boundary B-V₂ 530, each of the regions in the lower resolution LL subband, i.e., I-V_{2LL} 510, may be further decomposed into I-V_{3LL} 610, I-W_{3HL} 621, I-W_{3LH} 623, I-W_{3HH} 625. Accordingly, after the successive decomposition, the following subbands are generated: one subbands with the lowest image resolution I-V_{3LL} 610, three subbands I-W_{3HL} 621, I-W_{3LH} 623, I-W_{3HH} 625, three subbands with higher image resolution I-W_{2HL} 521, I-W_{2LH} 523, I-W_{2HH} 525, and three subbands with even higher image resolution.

During transmission, these boundary and image information may be sent using JSCC to protect the information against channel errors. First, the lowest resolution boundary B-V₃ 630 may be sent, step 926. This boundary information has the highest error protection. Next, the image information in the lowest resolution subband I-V_{3LL} 610 may be sent, step 928. This image information, again, has the highest error protection. In step 930, the image information in the lowest resolution subbands I-W_{3HL} 621, I-W_{3LH} 623, I-W_{3HH} 625 may be transmitted. The subbands I-V_{3LL} 610, I-W_{3HL} 621, I-W_{3LH} 623, and I-W_{3HH} 625 may be combined to reconstruct I-V_{2LL} 510 in a receiver, step 932.

In the next step, boundary information in a higher resolution may be successively transmitted, step 934, together with the image information in a higher resolution HL, LH, and HH subbands, step 936. Similarly, the subbands LL, HL, LH, and HH may be combined to reconstruct image information in a higher resolution, until the original image I-V₀ 310 is reconstructed, step 938. For example, boundary information in B-W₃ 640 may be sent, which, by combining B-V₃ 630, may generate the boundary at resolution B-V₂ 530, which has high protection. Then, the image information in I-W_{2HL} 521, I-W_{2LH} 523, I-W_{2HH} 525 may be sent, which may be combined with I-V_{2LL} 510 to reconstruct I-V_{1LL} 410. Next, boundary information in B-W₂ 540 may be sent, which may combine with B-V₂ 530, to generate the boundary at resolution B-V₁ 430, which has medium protection. Finally, the image information in I-W_{1HL} 421, I-W_{1LH} 423, I-W_{1HH} 425 may be sent, which may be combined with I-V_{1LL} 410 to reconstruct the original image I-V₀ 310 in the receiver.

While the method for multi-resolution boundary encoding has been described in connection with an exemplary embodiment, it will be understood that many modifications in light of these teachings will be readily apparent to those skilled in the art, and this application is intended to cover any variations thereof.

What is claimed is:

1. A method for applying multi-resolution boundary encoding to region based still image and video encoding, comprising:
dividing an original image into a plurality of regions, wherein a plurality of boundaries associated with the plurality of the regions is detected;
encoding each of the plurality of the boundaries, whereby each of the plurality of the boundaries contains different resolution coefficients;
decomposing each of the plurality of the regions in the original image into one or more subbands using the plurality of the boundaries with the highest resolution coefficients;
successively decomposing each of the plurality of the regions in a subband with lower resolution coefficients into one or more subbands using the plurality of the boundaries with lower resolution coefficients;
transmitting boundary and image information with the lowest resolution coefficients; and
successively transmitting boundary and image information with higher resolution coefficients.

2. The method of claim 1, wherein the encoding step includes encoding each of the plurality of the boundaries by two periodic wavelet series, whereby each of the plurality of the boundaries contains different resolution coefficients in each of the two periodic wavelet series.

3. The method of claim 1, wherein the decomposing step includes decomposing each of the plurality of the regions in the original image into four subbands using a region based subband encoding scheme.

4. The method of claim 3, wherein the decomposing step includes decomposing each of the plurality of the regions in the original image into a subband using low pass horizontal and low pass vertical frequency filters.

5. The method of claim 3, wherein the decomposing step includes decomposing each of the plurality of the regions in the original image into a subband using high pass horizontal and low pass vertical frequency filters.

6. The method of claim 3, wherein the decomposing step includes decomposing each of the plurality of the regions in the original image into a subband using low pass horizontal and high pass vertical frequency filters.

7. The method of claim 3, wherein the decomposing step includes decomposing each of the plurality of the regions in the original image into a subband using high pass horizontal and high pass vertical frequency filters.

8. The method of claim 1, wherein the successively decomposing step includes successively decomposing for at least three levels of decomposition.

9. The method of claim 1, further comprising reconstructing image information at a higher resolution in a receiver by combining the image information in the one or more lowest resolution subbands.

10. The method of claim 9, further comprising successively reconstructing image information at a yet higher resolution in the receiver by combining the image information in the one or more lower resolution subbands, until the original image is reconstructed.

11. An apparatus for applying multi-resolution boundary encoding to region based still image and video encoding, comprising:
means for dividing an original image into a plurality of regions, wherein a plurality of boundaries associated with the plurality of the regions is detected;
means for encoding each of the plurality of the boundaries, whereby each of the plurality of the boundaries contains different resolution coefficients;
means for decomposing each of the plurality of the regions in the original image into one or more subbands using the plurality of the boundaries with the highest resolution coefficients;
means for successively decomposing each of the plurality of the regions in a subband with lower resolution coefficients into one or more subbands using the plurality of the boundaries with lower resolution coefficients;
means for transmitting boundary and image information with the lowest resolution coefficients; and
means for successively transmitting boundary and image information with higher resolution coefficients.

12. The apparatus of claim 11, wherein the means for encoding step includes means for encoding each of the plurality of the boundaries by two periodic wavelet series, whereby each of the plurality of the boundaries contains different resolution coefficients in each of the two periodic wavelet series.

13. The apparatus of claim 11, wherein the means for decomposing step includes means for decomposing each of the plurality of the regions in the original image into four subbands using a region based subband encoding scheme.

14. A computer readable medium providing instructions for applying multi-resolution boundary encoding to region based still image and video encoding, the instructions comprising:
dividing an original image into a plurality of regions, wherein a plurality of boundaries associated with the plurality of the regions is detected;
encoding each of the plurality of the boundaries, whereby each of the plurality of the boundaries contains different resolution coefficients;
decomposing each of the plurality of the regions in the original image into one or more subbands using the plurality of the boundaries with the highest resolution coefficients;
successively decomposing each of the plurality of the regions in a subband with lower resolution coefficients into one or more subbands using the plurality of the boundaries with lower resolution coefficients;
transmitting boundary and image information with the lowest resolution coefficients; and
successively transmitting boundary and image information with higher resolution coefficients.

15. The computer readable medium of claim 14, wherein the instructions for encoding step includes encoding each of the plurality of the boundaries by two periodic wavelet series, whereby each of the plurality of the boundaries contains different resolution coefficients in each of the two periodic wavelet series.

16. The computer readable medium of claim 14, wherein the instructions for decomposing step includes decomposing each of the plurality of the regions in the original image into four subbands using a region based subband encoding scheme.

17. The computer readable medium of claim 16, wherein the instructions for the decomposing step includes decomposing each of the plurality of the regions in the original image into a subband using low pass horizontal and low pass vertical frequency filters.

18. The computer readable medium of claim 16, wherein the instructions for the decomposing step includes decomposing each of the plurality of the regions in the original image into a subband using high pass horizontal and low pass vertical frequency filters.

19. The computer readable medium of claim 16, wherein the instructions for the decomposing step includes decomposing each of the plurality of the regions in the original image into a subband using low pass horizontal and high pass vertical frequency filters.

20. The computer readable medium of claim 16, wherein the instructions for the decomposing step includes decomposing each of the plurality of the regions in the original image into a subband using high pass horizontal and high pass vertical frequency filters.
